(19) United States
(12) Patent Application Publication
(10) Pub. No.: US 2004/0041938 A1
(43) Pub. Date: Mar. 4, 2004

(54) Embedded type camera module

(75) Inventors: Tae-Jun Seo, Kyunggi-Do (KR); In-Soon Yu, Suwon-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/449,604

(22) Filed: Jun. 2, 2003

(30) Foreign Application Priority Data
Aug. 28, 2002 (KR) 2002-51257

(51) Int. Cl. H04N 5/225

(52) U.S. Cl. 348/340

(57) ABSTRACT

Disclosed herein is an embedded type camera module. The embedded type camera module includes a transparent plate, an image sensor chip, a digital signal processing chip, and one or more peripheral chips. A circuit pattern is formed on one surface of the transparent plate which is connected with a connector. The image sensor chip is electrically connected to the circuit pattern and constructed to receive image signals inputted from the outside. The digital signal processing chip converts signals received from the image sensor chip into digital signals. The peripheral chips are mounted a printed circuit board formed in a product to be disposed in conjunction with the image sensor chip and the digital signal processing chip. The transparent plate, the image sensor chip, the digital signal processing chip and the peripheral chips are packaged together.

### BACKGROUND OF THE INVENTION

1. Field of the Invention

The present invention relates generally to an embedded type camera module, and more particularly to an embedded type camera module, in which its printed circuit board and its protective cover are integrated into a single body, so the numbers of its component parts and its manufacturing steps can be reduced to decrease its manufacturing cost, the air-tightness of its image recognition unit can be improved, and the electrical connection of its digital signal processing chip to its image sensor chip can be simplified.

2. Description of the Prior Art

Currently, mobile phone manufacturing companies have developed, produced and marketed mobile phones containing embedded type camera modules. Such camera modules embedded in mobile phones have been developed in various forms according to the component elements and packing methods of camera modules. The embedded type camera modules have been applied to portable notebook computers as well as mobile phones.

The camera modules are implemented as Digital Signal Processor (DSP) chips. The DSP chips function to convert analog signals, such as image or voice, into digital signals. The DSP chips are mainly used in communication apparatuses, such as Automatic Response Systems (ARSs), modems and wireless communication devices. The DSP chips are also used in Digital Versatile Disks (DVDs) and set-top boxes that allow Internet access through television sets.

In general, such embedded type camera modules are classified into an one-chip module in which one image sensor chip or one image sensor chip containing a DSP chip is packaged, a two-chip module in which an image chip and a DSP chip are integrated with each other and packaged together, and a multi-chip modules in which an image sensor chip, a DSP chip and an peripheral additional chip are integrated with one another and packaged together.

In the meantime, the embedded type camera modules are packaged by various packaging methods, such as a Leadless Chip Carrier (LCC) method, a Chip On Board (COB) method, a Chip On Flexible Printed Circuit Board (COFPCB) method, a Chip Scale Package (CSP) method, a Chip Scale Package (CSP) method, a Ball Grid Array (BGA) method, and the like.

Currently, in the field of mobile phones, there is a tendency to miniaturize mobile phones according to consumers' desire and to use multi-chip camera modules, in which an image sensor chip, a DSP chip and additional peripheral chips are integrated, as a camera module embedded in a mobile phone body.

Accordingly, in manufacturing embedded type camera modules for mobile phones, there is required a technology in which the sizes of entire modules are reduced and various chips are integrated with one another.

Since the embedded type camera modules are equipped in the mobile phones, design to reduce the size and height of the mobile phones is required. However, this design has limitation in the simplicity of a process.

A conventional embedded type camera module is described with reference to FIGS. 1 and 2 below. A circuit pattern 12 is plated to connect the related portions of an image sensor chip 10 and a connector 1 to one another. A Flexible Printed Circuit Board (FPCB) 20 provided with a through hole 21 is provided to allow images to reach an image recognition unit 11 of the image sensor chip 10. Bump balls are disposed on the circuit pattern 12 formed on the lower surface of the FPCB 20 and the pad of the image sensor chip 10. The pad of the image sensor chip 10 is electrically connected to the plated pattern of the FPCB 20, and the pad of the image sensor chip 10 is attached to the plated pattern of the FPCB 20 using a glue or adhesive tape.

When the image sensor chip 10 is attached to the FPCB 10, both attachment and electrical connection can be realized using an Anisotropic Conductive Film (ACF) or Anisotropic Conductive Paste (ACP) at the same time.

A protective cover 30 having a size larger than that of the image sensor chip 10 is attached to the FPCB 20 over the through hole 21. The protective cover 30 may be a glass or Infrared (IR)-filter. When the protective cover 30 is attached to the FPCB 20, a glue or adhesive tape is applied to the edge of the lower surface of the protective cover 30 to guarantee air-tightness between the protective cover 30 and the FPCB 20.

Additionally, to increase the reliability of the image sensor chip 10, the image sensor chip 10 together with the protective cover 30 is made to be encapsulated with a mold.

However, the above-described conventional camera module manufacturing method is problematic in that the bonding of the image sensor onto the FPCB and the air-tightening of the protective cover with regard to the FPCB may cause the malfunction of the entire camera module. That is, the gap may be created between the image sensor and the FPCB or between the protective cover and the FPCB due to the above-described defective processing, so impurities are infiltrated through the gap into the camera module, thus causing the camera module to malfunction.

The molding process carried out to overcome the above-described problem causes the number of packaging steps to increase, so the productivity of the camera modules is reduced and the manufacturing cost of the camera modules is increased, thus increasing the selling prices of the camera modules.

In addition, a DSP chip mounted on a printed circuit board to convert image recognition signals into digital signals and other semi-conductor chips are electrically mounted to manufacture the camera module and occupy the large portion of an inside space, so the mounting of these chips restricts the miniaturizing design of a mobile phone.

### SUMMARY OF THE INVENTION

Accordingly, the present invention has been made keeping in mind the above problems occurring in the prior art, and an object of the present invention is to provide an embedded type camera module, in which its printed circuit board and its protective cover are integrated into a single body, so the numbers of its component parts and its manufacturing steps can be reduced to decrease its manufacturing cost, the air-tightness of its image recognition unit can be improved, and the electrical connection of its digital signal processing chip to its image sensor chip can be simplified.

In order to accomplish the above object, the present invention provides an embedded type camera module, comprising a transparent plate on one surface of which a circuit pattern is formed being connected with a connector; and an image sensor chip electrically connected to the circuit pattern and constructed to receive image signals inputted from the outside; wherein the transparent plate and the image sensor chip are packaged together.

In addition, the present invention provides an embedded type camera module, comprising a transparent plate on one surface of which a circuit pattern is formed being connected with a connector; an image sensor chip electrically connected to the circuit pattern and constructed to receive image signals inputted from the outside; and a digital signal processing chip to convert signals received from the image sensor chip into digital signals; wherein the transparent plate, the image sensor chip and the digital signal processing chip are packaged together.

In addition, the present invention provides an embedded type camera module, comprising a transparent plate on one surface of which a circuit pattern is formed being connected with a connector; an image sensor chip electrically connected to the circuit pattern and constructed to receive image signals inputted from the outside; a digital signal processing chip to convert signals received from the image sensor chip into digital signals; and one or more peripheral chips mounted a printed circuit board formed in a product to be disposed in conjunction with the image sensor chip and the digital signal processing chip; wherein the transparent plate, the image sensor chip, the digital signal processing chip and the peripheral chips are packaged together.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of a conventional camera module;

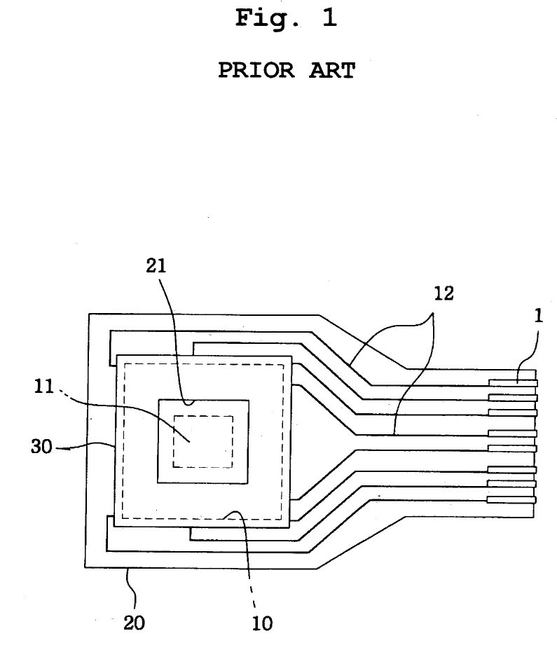

FIG. 2 is a longitudinal view of the conventional camera module;

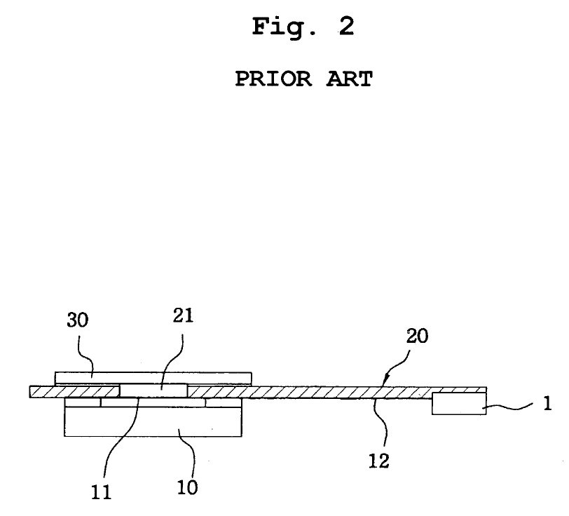

FIG. 3 is a plan view showing a camera module of an embodiment of the present invention in which an image sensor chip is mounted on a transparent plate;

FIG. 4 is a front view of FIG. 3;

FIG. 5 is a plan view showing a camera module of another embodiment of the present invention in which an image sensor chip and a DSP chip are mounted on a transparent plate; and

FIG. 6 is a plan view showing a camera module of another embodiment of the present invention in which an image sensor chip, a DSP chip and peripheral chips are mounted on a transparent plate.

### DESCRIPTION OF THE PREFERRED EMBODIMENTS

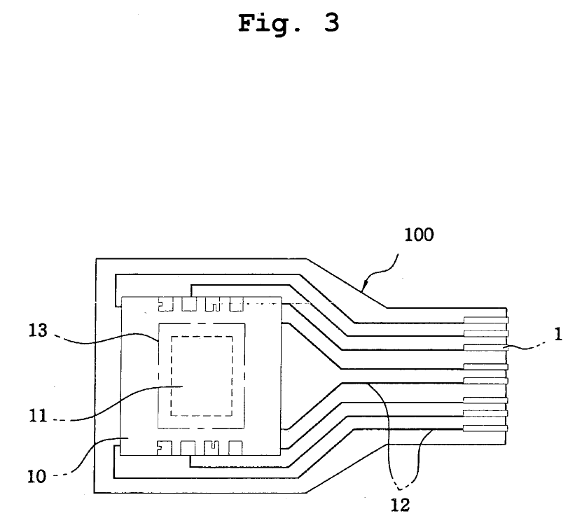

Reference now should be made to FIGS. 3 to 6, in which the same reference numerals are used throughout the different drawings to designate the same or similar components.

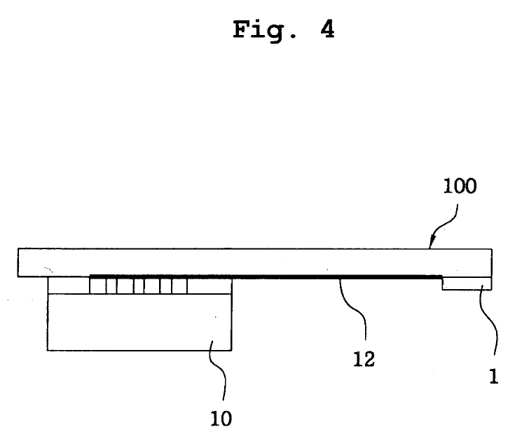

FIG. 3 is a plan view showing a camera module of an embodiment of the present invention in which an image sensor chip 10 is mounted on a transparent plate 100. FIG. 4 is a front view of FIG. 3.

A circuit pattern 12 is printed on one surface of the transparent plate 100. A connector 1 is mounted on a transparent plate 100. The image sensor chip 10 is electrically connected to the other end of the circuit pattern 12 to receive image signals from the outside.

The transparent plate 100 is provided with a transmitting portion 13 to allow images to reach an image recognition unit 11 of the image sensor chip 10.

The transparent plate 100 is made of plastic material, and is preferably constructed to have IR-filter characteristics. The transparent plate 100 and the image sensor chip 10 are electrically connected to each other by an anisotropic conductive adhesive.

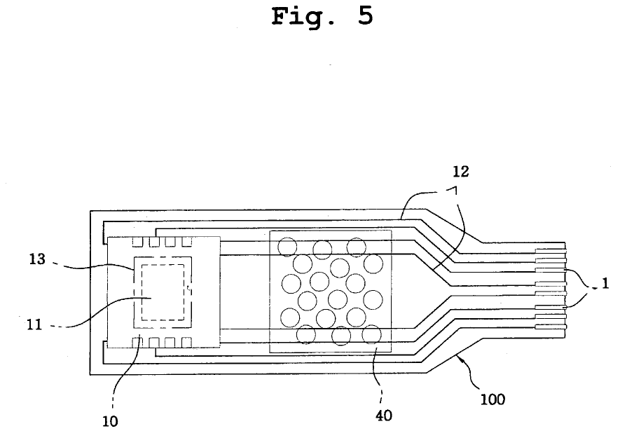

FIG. 5 is a plan view showing a camera module of another embodiment of the present invention in which an image sensor chip 10 and a DSP chip 40 are mounted on a transparent plate 100 that is a principal component of a camera module of the present invention. A transparent plate on one surface of which a circuit pattern is formed is connected with a connector. The image sensor chip 10 is electrically connected to the circuit pattern 12 and constructed to receive image signals inputted from the outside. The DSP chip 40 converts signals received from the image sensor chip 10 into digital signals. The transparent plate 100, the image sensor chip 10 and the DSP chip 40 are packaged together.

The transparent plate 100 is provided with a transmitting portion 13 to allow images to reach an image recognition unit 11 of the image sensor chip 10. The transparent plate 100 is made of plastic material, and is preferably constructed to have IR-filter characteristics.

The transparent plate 100 and the image sensor chip 10 are electrically connected to each other by an anisotropic conductive adhesive.

The related portions of the image sensor chip 10 and the DSP chip 40 mounted on the transparent plate 100 are electrically connected to each other by the circuit pattern 12. The electrical connection is implemented in such a way that a bump ball is formed on the pad of the image sensor chip 10 and an anisotropic conductive paste is applied to the transparent plate 100, so the plated portion of the circuit pattern and the chip 10 can be electrically connected to each other.

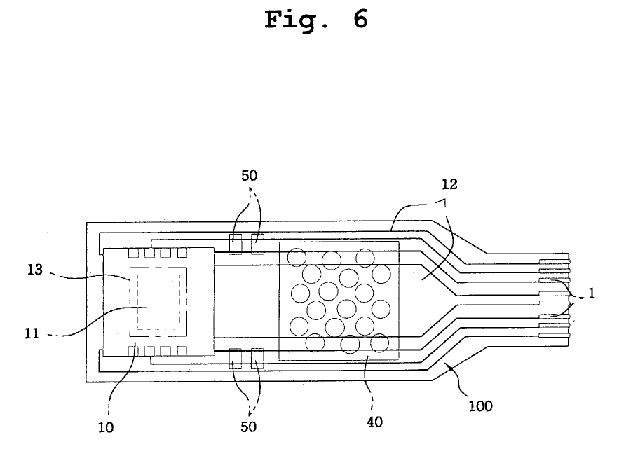

FIG. 6 is a plan view showing a camera module of another embodiment of the present invention in which an image sensor chip 10, a DSP chip 40 and one or more peripheral chips 40 are mounted on a transparent plate 100. A transparent plate on one surface of which a circuit pattern is formed is connected with a connector. The image sensor chip 10 is electrically connected to the circuit pattern 12 and constructed to receive image signals inputted from the outside. The DSP chip 40 converts the image signals received from the image sensor chip 10 into digital signals. The peripheral chips 50 are mounted a printed circuit board formed in a product to be disposed in conjunction with the image sensor chip 10 and the DSP chip 40. The transparent plate 100, the image sensor chip 10, the DSP chip 40 and the peripheral chips 50 are packaged together.

The transparent plate 100 is provided with a transmitting portion 13 to allow images to reach an image recognition unit 11 of the image sensor chip 10. The transparent plate 100 is made of plastic material, and is preferably constructed to have IR-filter characteristics.

The transparent plate 100, the image sensor chip 10 and the peripheral chips 50 are electrically connected to each other by an anisotropic conductive adhesive.

The related portions of the image sensor chip 10, the DSP chip 40 and the peripheral chips 50 mounted on the transparent plate 100 are electrically connected to each other by the circuit pattern 12.

The operation and effect of the camera module of the present invention is described below.

The transmitting portion occupies a space except for a space in which the circuit pattern is formed. Accordingly, the image sensor chip 10 attached to the circuit pattern 12 plated on the lower surface of the transparent plate 100 by an anisotropic conductive adhesive can recognize images not through a conventional through hole directly formed in a conventional transparent plate but through the transmitting portion.

Additionally, the transparent plate of the present invention performs the function of a conventional protective cover. In more detail, the transparent plate of the present invention on which the circuit pattern is formed replaces a conventional FPCB and a conventional protective cover, so the camera module of the present invention is advantageous in that the manufacturing cost of the camera module is significantly reduced.

However, the transparent plate may not be flexible, differently from the conventional FPCB. Accordingly, when the camera module of the present invention is applied to a mobile phone or the like, it is preferable to apply to the mobile phone or the like an embedded type camera module having a relatively short distance between the image sensor chip and the connector provided at the end of the circuit pattern.

As described above, the embodied type camera module that can be applied to the mobile phone can be also applied to other mobile communication devices, such as a Personal Digital Assistant (PDA), a notebook computer, etc.

In the meantime, the circuit pattern formed on the transparent plate is electrically connected to a DSP chip that is mounted on the inside printed circuit board of a mobile phone or communication device and converts analog signals, such as images or voices, into digital signals, which constitutes a single module.

The DSP chip can be electrically connected to the circuit pattern by applying bump balls on the pad of the DSP chip or using a ball grid array manner.

Additionally, in another embodiment of the present invention, the image sensor chip, the DSP chip and the peripheral chips are used while being mounted on the circuit pattern of the transparent plate as shown in FIG. 6. In this case, each of the peripheral chips may be exemplified by a capacitor or Static Read Only Memory (SPAM). The peripheral chips can be mounted on the transparent plate using a surface mount technology, so a plurality of chips can be mounted on the circuit pattern of the transparent plate, thus allowing the corresponding device to be properly used as an embedded type camera module.

That is, when the embedded type camera module of the present invention is applied to a miniaturized product, such as a mobile phone, the limitation of the miniaturized phone body of the mobile phone can be overcome.

In the embodiments of the present invention, a single transparent plate functions as both a conventional flexible body and a conventional protective cover, so the transmission portion serves while being brought into contact with the image sensor chip, thus preventing malfunction that may be caused by the infiltration of impurities and improving the reliability of a product.

As described above, the present invention provides an embedded type camera module, in which its printed circuit board and its protective cover are integrated into a single body, so the numbers of its component parts and its manufacturing steps can be reduced to decrease its manufacturing cost, the air-tightness of its image recognition unit can be improved, and the electrical connection of its digital signal processing chip to its image sensor chip can be simplified.

Additionally, an image sensor chip, an image sensor chip and a DSP chip, or an image sensor chip, a DSP chip and peripheral chips electrically connected to a single transparent plate can be packaged as a single module, so the camera module of the present invention can be used as an embedded type part and can realize the miniaturization of a product.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An embedded type camera module, comprising:
a transparent plate on one surface of which a circuit pattern is formed being connected with a connector; and
an image sensor chip electrically connected to the circuit pattern and constructed to receive image signals inputted from the outside;
wherein the transparent plate and the image sensor chip are packaged together.

2. The camera module according to claim 1, wherein the transparent plate is provided with a transmitting portion so as to transmit the image signals to an image recognition of the image sensor chip.

3. The camera module according to claim 1, wherein the transparent plate is made of plastic material, and has infrared filter characteristics.

4. The camera module according to claim 1, wherein the transparent plate and the image sensor chip are electrically connected to each other by an anisotropic conductive adhesive.

5. An embedded type camera module, comprising:
a transparent plate on one surface of which a circuit pattern is formed being connected with a connector; and
an image sensor chip electrically connected to the circuit pattern and constructed to receive image signals inputted from the outside; and
a digital signal processing chip to convert signals received from the image sensor chip into digital signals;
wherein the transparent plate, the image sensor chip and the digital signal processing chip are packaged together.

6. The camera module according to claim 6, wherein the transparent plate is provided with a transmitting portion so as to transmit the image signals to an image recognition of the image sensor chip.

7. The camera module according to claim 6, wherein the transparent plate is made of plastic material, and has infrared filter characteristics.

8. The camera module according to claim 6, wherein the image sensor chip and the digital signal processing chip mounted on the transparent plate are electrically connected to each other by an anisotropic conductive adhesive.

9. The camera module according to claim 6, wherein the image sensor chip and the digital signal processing chip mounted on the transparent plate are electrically connected at related portions to each other by the circuit pattern.

10. An embedded type camera module, comprising:
a transparent plate on one surface of which a circuit pattern is formed being connected with a connector; and
an image sensor chip electrically connected to the circuit pattern and constructed to receive image signals inputted from the outside;
a digital signal processing chip to convert signals received from the image sensor chip into digital signals; and
one or more peripheral chips mounted a printed circuit board formed in a product to be disposed in conjunction with the image sensor chip and the digital signal processing chip;
wherein the transparent plate, the image sensor chip, the digital signal processing chip and the peripheral chips are packaged together.

11. The camera module according to claim 11, wherein the transparent plate is provided with a transmitting portion so as to transmit the image signals to an image recognition of the image sensor chip.

12. The camera module according to claim 11, wherein the transparent plate is made of plastic material, and has infrared filter characteristics.

13. The camera module according to claim 11, wherein the image sensor chip, the digital signal processing chip and the peripheral chips mounted on the transparent plate are electrically connected to one another by an anisotropic conductive adhesive.

14. The camera module according to claim 11, wherein the image sensor chip, the digital signal processing chip and the peripheral chips mounted on the transparent plate are electrically connected at related portions to one another by the circuit pattern.
